(19) United States
(12) Patent Application Publication
(10) Pub. No.: US 2005/0176480 A1
(43) Pub. Date: Aug. 11, 2005

(54) Cell phone bungie cord

(76) Inventor: Stewart Hairston Kemp, Grand Bay, AL (US)

Correspondence Address: Stewart H. Kemp, 5192 Southern Oaks Trail, Grand Bay, AL, 36541, US

(21) Appl. No.: 10/351,842

(22) Filed: Feb. 7, 2004

(51) Int. Cl. H04B 1/38; H04M 1/00

(52) U.S. Cl. 455/575.6; 455/575.1

(57) ABSTRACT

The “Cell Phone Bungle” is a precision made and engineered device to allow the user to avoid damaging or losing their cell phone or other personal items. It is made of high quality velcro fasteners to secure the cell phone to the bungle and also secure the bungle to a belt loop, belt, gym bag, purse, etc. The bungle is made from vinyl coated memory cord which is considered to be one of the best on the market. The Velcro fastener which secures the bungle to the person of article has a chrome plated swivel fastener to avoid a tangled bungle cord. It is capable of holding up to one pound and maintaining its adhesive qualities from 0 to 110 degrees. This product has been thoroughly tested and inspected by an engineer to guarantee is quality and durability.

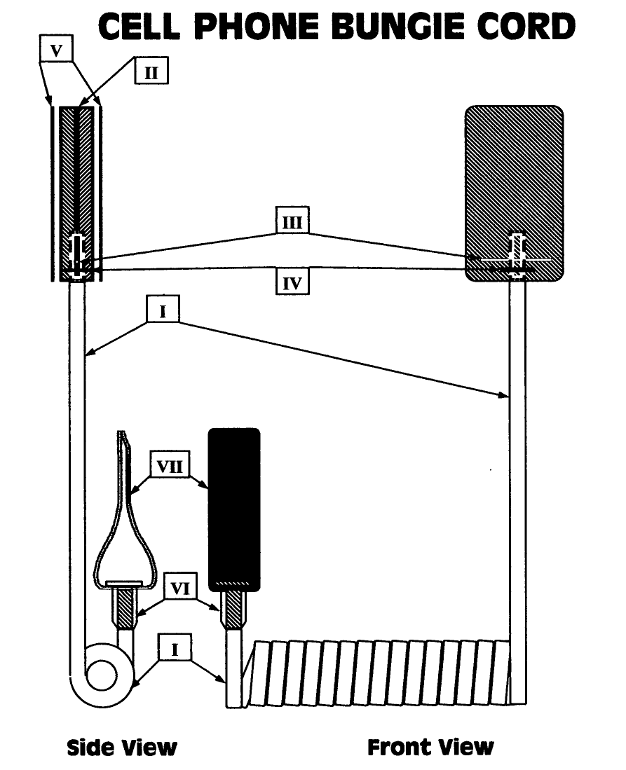

### DRAWINGS

Reference Numerals (attached)

### DETAILED DESCRIPTION OF THE INVENTION—FIGURES I-VI

Figure. I—Extendable and retractable memory cord covered with multi vinyl coated tubing for memory positioning. The vinyl tubing's center is filled with two vinyl coated stranded copper wires to provide strength, size retention, endurance and longevity. The memory cord begins with a straight section of the described chord 3.75 to 7.75 inches long. This straight section is followed by a 2.375 to 4.625 inch section of extendable and retractable memory cord ending with another straight section of memory cord 0.5 to 1.365 inches in length. There is no splice or break in the before described memory cord in its entirety.

Figure II—The invention is fitted on the 3.75 to 7.75 inch end of cord with two industrial grade rectangular pieces with rounded or square corners of hook and latch material commonly referred to as Velcro, measuring 1.125 to 1.625×1.75 to 2.375 inches. The two latch sides of the hook and latch material of attached together with permanent industrial pressure sensitive adhesive. The end of the memory referred to above must be inserted into the latch pads exactly 0.625″ before adhering (this 0.625 inch measurement is critical for the safe use of the invention with products chosen by owner).

Figure III—A stainless steel pin measuring 1-inch long×2 mm in diameter must be placed 0.375 inches in sided the latch pad prior to adding memory cord end and adhering the latch together. This is added for consistent drop control and product strength and durability.

Figure IV—A heavy-duty black colored staple is applied to the latch pad 0.125 inch below the stainless steel pin (figure III) while straddling the memory cord inside the latch pad.

Figure V—The invention is delivered with two industrial grade rectangular pieces with rounded or square corners of hook and latch material commonly referred to as Velcro, measuring 1.125 to 1.625×1.75 to 2.375 inches. These two hook pads are to be attached to the back or the cell phone, other items of the nature as well as personal items. This will allow the memory cord to be attached to the item desired.

Figure VI—The straight end of the memory cord measuring 0.5 to 1.365 inches in length is fitted with a chromed steel swivel head fastener 0.5 inches in length. It is attached with a pressure application tool.

Figure VII—Prior to attached the above described rivet a doubled sided 0.5 inch wide strip of industrial grade hook and latch material 4.75 to 7.125 inches in length is slid onto the memory cord straight end measuring 0.5 to 1.365 inches in length through a 6 mm hole cut into the middle of the hook and latch strap.

1. I, Stewart H. Kemp, do hereby claim that the “Cell Phone Bungle” is made of the best materials available to me at the time of manufacture.
I, Stewart H. Kemp, do hereby claim that the “Cell Phone Bungle's” memory cord to be approximately 3.0″ in length while relaxed and up to 23.0″ in the extended “in use” position.
I, Stewart H. Kemp, do hereby claim that the “Cell Phone Bungle” to fit or attach to any small item, ie. beepers, flash lights, remote controls, hunting items, small tools, wallets.
I, Stewart H. Kemp, do hereby claim that the “Cell Phone Bungle” will hold or secure items up to one pound.
I, Stewart H. Kemp, do hereby claim that the “Cell Phone Bungle” will attach to belt loops, belts, gym bags, purse straps or others items used to secure personal belongings as long as less that 1.25″ in diameter.
I, Stewart H. Kemp, do hereby claim that the “Cell Phone Bungle” will maintain its holding ability in temperatures from 0 degrees to 110 degrees.
I, Stewart H. Kemp, do hereby claim that the “Cell Phone Bungle” that the holding strap is made from Velcro 4.0, to 10″ in length.
I, Stewart H. Kemp, do hereby claim that the “Cell Phone Bungle” will significantly cut the loss or breakage of the items it is used to protect.
I, Stewart H. Kemp, do hereby claim that the “Cell Phone Bungle” uses a swivel chrome fastener to prevent knotting of bungle cord.
I, Stewart H. Kemp, do hereby claim that the “Cell Phone Bungle” will STOP THAT DROP creating a significant decline in the loss and damage of cell phones and other small personal items when used as directed.
I, Stewart H. Kemp, do hereby claim that the “Cell Phone Bungle” will significantly decline the loss and damage of cell phones and other small personal items when used during biking, recreation vehicles, equine events, fishing, boating, on the Job, construction work, motorcycling, etc.
I, Stewart H. Kemp, do hereby claim that the “Cell Phone Bungle” can relieve the stress of constantly looking for your cell phone or possible loss or damage to your cell phone.
